(19) United States
(12) Patent Application Publication
(10) Pub. No.: US 2026/0200680 A1
(43) Pub. Date: Jul. 16, 2026

(54) HIGH SPEED AUTONOMUS MOBILE ROBOT (AMR) PICK-UP/DROP-OFF CONVEYOR SYSTEM

(71) Applicant: Alternative Engineering, Inc., Belmont, MI (US)

(72) Inventors: D. Robert Rodriguez, Belmont, MI (US); Steven R. Kakoczki, Wyoming, MI (US); John R. McClary, Comstock Park, MI (US)

(21) Appl. No.: 19/449,305

(22) Filed: Jan. 14, 2026

Related U.S. Application Data
(60) Provisional application No. 63/745,237, filed on Jan. 14, 2025.

(51) Int. Cl. B65G 13/02; B65G 13/11; B65G 47/24; B65G 47/52

(52) U.S. Cl. CPC B65G 13/02; B65G 13/11; B65G 47/24; B65G 47/52

(57) ABSTRACT

A high-speed AMR pick-up and drop-off conveyor system includes a roller conveyor joined to a cantilevered transfer conveyor such that both conveyors are driven by a motorized drive roller (MDR) allowing the conveyor system to achieve a low-profile. The transfer conveyor includes a plurality of alignment fingers allowing an approaching AMR to align itself with the transfer conveyor to provide a continuous pick-up or drop-off flow of packages without stopping under the transfer conveyer.

### FIELD OF THE INVENTION

The present invention relates to conveyor systems and, more particularly, to a conveyor system that uses an autonomous mobile robot (AMR) to pick-up and drop-off packages in a continuous flow environment.

### BACKGROUND

An automatic guided vehicle (AGV) is well known in the art and is typically a cart type vehicle that moves about a factory space using an on-floor control path or a preprogrammed control map. Thus, the control guidance is known and/or preloaded into the AGV. In contrast, an autonomous mobile robot (AMR) is a type of robot that can understand and move through its environment without being overseen directly by an operator or limited to a fixed, predetermined path. The AMR is typically a small roving cart type vehicle that uses a combination of navigation systems including imaging, the global position system (GPS) and other wireless guidance. While using this form of navigation, the AMR can control its own work path throughout factory space.

When using the AMR, a problem occurs in that the robotic cart easily moves throughout factory space, but there is no efficient way to continuously load and/or remove cargo from the AMR. If a loaded AMR drives to a destination within a factory the AMR must stop, use some device to remove its load and then resume its travel. This start-load/unload-resume cycle takes up a significant amount of time and limits the throughput of the package handling system. An innovative solution is required to quickly transfer the cargo on and off the AMR to increase the system throughput.

### BRIEF DESCRIPTION OF THE FIGURES

The accompanying figures, where like-reference numerals refer to identical or functionally similar elements throughout the separate views and which together with the detailed description below are incorporated in, and form part of the specification, serve to further illustrate various embodiments and to explain various principles and advantages all in accordance with the present invention.

FIG. 1A is a perspective view showing the continuous flow, high-speed pick-up and drop-off conveyor system in accordance with an embodiment of the invention.

FIG. 1B is a top view of the conveyer system shown in FIG. 1.

FIG. 1C is a cross-sectional view shown through lines A-A as shown in FIG. 1B.

FIG. 1D is an end view shown looking at a transfer conveyer as seen in FIG. 1A.

FIG. 2A and FIG. 2B are flow chart diagrams illustrating the pick-up and drop-off methods used by an AMR.

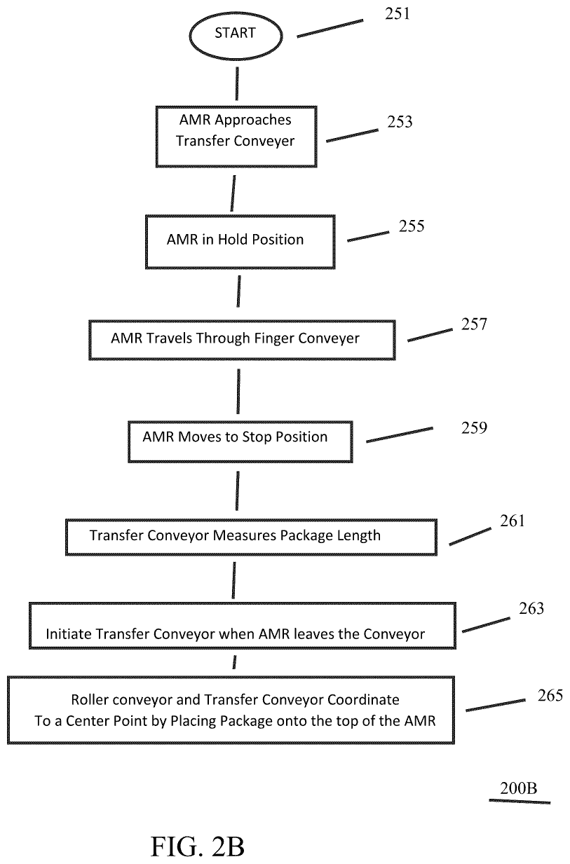

Skilled artisans will appreciate that elements in the figures are illustrated for simplicity and clarity and have not necessarily been drawn to scale. For example, the dimensions of some elements in the figures may be exaggerated relative to others to help improve understanding of embodiments of the present invention.

### DETAILED DESCRIPTION

Before describing in detail embodiments that are in accordance with the present invention, it should be observed that the embodiments reside primarily in combinations of method steps and apparatus components related to high-speed autonomous pick-up and drop-off stands for use with an autonomous mobile robot (AMR). Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art, having the benefit of the description herein.

In this document, relational terms such as first and second, top and bottom, and the like may be used solely to distinguish one entity or action from another entity or action without necessarily requiring or implying any actual such relationship, or order between such entities or actions. The terms “comprises,” “comprising,” or any other variation thereof, are intended to cover a non-exclusive inclusion, such that a process, method, article or apparatus that comprises a list of elements does not include only those elements but may include other elements not expressly listed or inherent to such process, method, article or apparatus. An element proceeded by “comprises . . . a” does not, without more constraints, preclude the existence of additional identical elements in the process, method, article, or apparatus that comprises the element.

### Continuous-Flow High Speed Conveyor System Overview

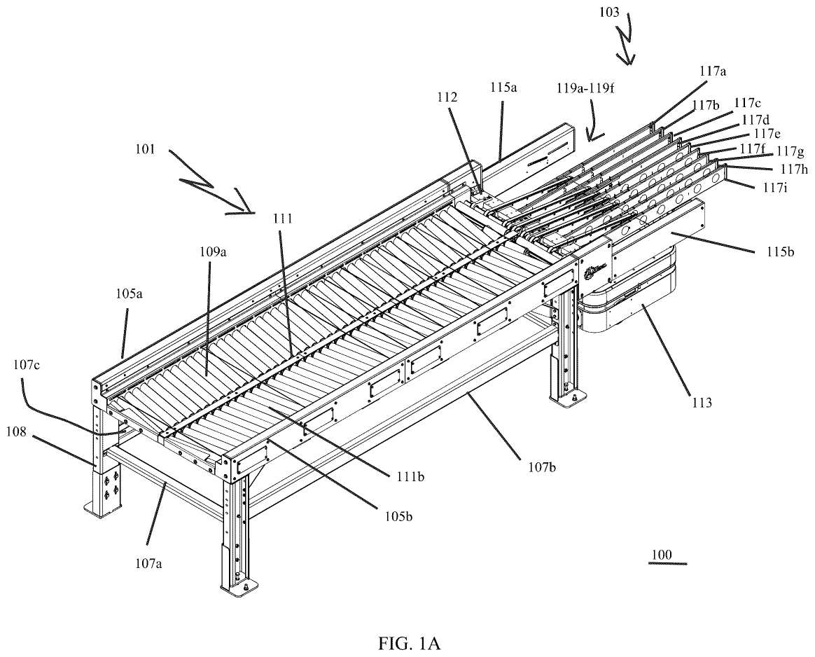

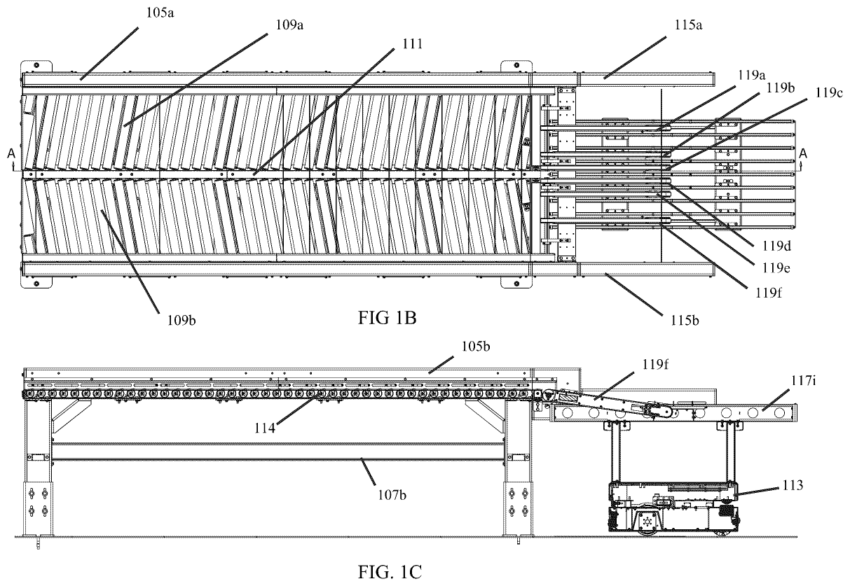

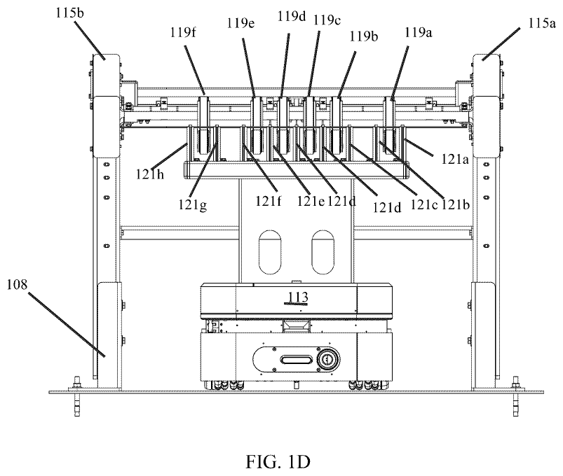

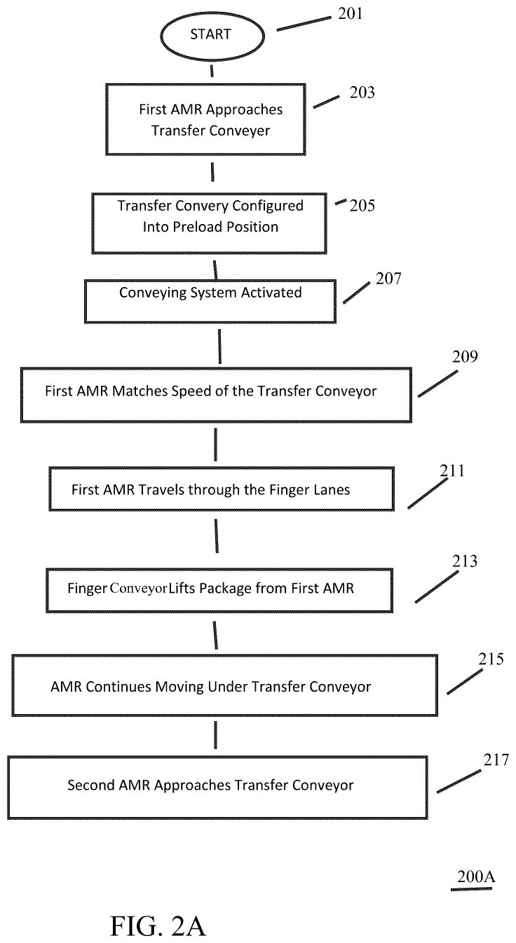

As seen in FIG. 1A, a continuous-flow, high speed conveyor system 100 uses uniquely designed components to buffer and/or transfer an infinite number of package shapes and weights to and from an AMR, AGV or other robotic vehicle. As noted herein, the system 100 uses a low-profile roller conveyor 101 that is integrated with a transfer conveyor 103. As described herein, the transfer conveyer 103 is cantilevered and includes a plurality of finger guides forming conveyer lanes that allow the AMR to drive through transfer conveyor 103 without stopping. As described herein, the roller conveyor 101 uses motorized drive rollers (MDR) to achieve a compact roller conveyor profile. Since the transfer conveyor 103 is cantilevered, and positioned at a pre-determined pitch, which allows for an “on-the-fly” transfer of parcels to and from an AMR. As described herein, roller centers, belt lane widths and space between adjacent belts can be easily configured to allow the transfer conveyor to dictate even the smallest package that can be conveyed. In some situations, the system can also place a high demand on the AMR to maintain a consistent and accurate docking engagement with the system.

In use, the continuous-flow high speed conveyor system can be configured either as a “drop-off” stand, i.e. allowing the AMR to drop-off packages or as a “pick-up” stand, i.e. allowing the AMR to pick-up packages. The pick-up stand illustrated includes a self-centering ‘herringbone’ style MDR roller conveyor, to center packages before they reach the transfer conveyor. The AMR interfaces with the transfer conveyer 103 using a plurality of vanes configured on at the top of the AMR. The customer's largest and smallest package sizes along with the package weights determine the number of lanes and spacing in the transfer conveyer 103. Thus, the system enables easy movement of a customer's largest and/or smallest package sizes with varying weights.

### The Low-Profile Roller Conveyor

As seen in FIG. 1A to FIG. 1D, the roller conveyor 101 is assembled using frame members 105a, 105b and brace members 107a, 107b, 107c, 107d to form a rigid structure. A plurality of feet 108 lift the roller conveyor off the floor a predetermined distance. The first row of rollers 109a and second row of rollers 109b are separated by a spine member 111 and work to rotate and convey packages to and from the transfer conveyer 103 as needed. Those skilled in the art will recognize that the roller conveyor 101 can be configurated with its rollers 109a, 109b oriented either in a straight or slanted configuration, depending on if self-centering is desired. The slanted configuration, which is sometimes called a herringbone conveyer, drives packages toward the center of the conveyor and therefore is self-centering. Those skilled in the art will recognize the herringbone configuration typically uses two rows of rollers 109a, 109b that are slanted toward the center of the conveyor. This allows packages on the roller conveyor to be easily indexed toward the spine 111 as the box or package moves toward the end of the transfer conveyor. The “herringbone” configuration is most often used in the system 100 when configured to drop-off packages at the AMR 113.

As seen best in FIG. 1C, in either configuration, the roller conveyor 101 uses one or more motorized drive rollers (MDR) 114 that are self-powered without the need to be rotated using a belt and external motor. A novel aspect of the system 101 is the use of the MDR driven conveyor. This MDR 114 makes the roller conveyor a unique part of a “continuous flow” conveyor system because of its low-profile design. Instead of using one or more large external motors under the conveyor with a belt drive to rotate the spindles, the MDR 114 roller conveyor has self-powered rollers to greatly reduce the conveyor's overall profile. This allows a low-profile AMR 113 to easily mesh and interface with the transfer or “finger” conveyors 103 and transfer packages and cargo to and from the AMR 113. Those skilled in the art will further recognize that the “low profile” occurs from the top of rollers to the bottom of the conveyor frame thus allowing for a substantially smaller cross-sectional area.

### The Cantilevered Transfer Conveyor

As seen in FIGS. 1A to 1D, a transfer conveyor 103 is integrated at one end of the roller conveyer 101. The transfer conveyer 103 includes a plurality of arms 115a, 115b that extend outward from the end 112 of the roller conveyor 101. Within the arms 115a, 115b, are a plurality of lanes formed by alignment fingers 117a, 117b, 117c, 117d, 117e, 117f, 117g, 117h, and 117i. The alignment fingers are designed to be narrow and elongated where their size and number will depend on both the package size and particular AMR used to pick-up or drop-off the package. Between the end 112 of the roller conveyor 10, a number of belts are used to form a finger conveyer. Each of the belts 119a, 119b, 119c, 119d, 119e, 119f are wrapped around a set of fingers to form a conveying lane. In the example shown herein, six (6) conveying lanes are formed. In the case of a package pick-up, as a package reaches the end 112 of the roller conveyer 101, one or more of the belts 119a, 119b, 119c, 119d, 119e and 119f will frictionally engage with and/or convey a package to the top of the AMR 113. In the case of a package drop-off, a package will slide from the top of the AMR 113 until it engages with belts 119a, 119b, 119c, 119d, 119e, 119f where the belts will raise a package onto the roller conveyor 101.

As seen in FIG. 1D, when in use, the AMR will orient itself to pass through the plurality of fingers 121a, 121b, 121c, 121d, 121e, 121f, 121g, 121h at top surface of the AMR. This permits the AMR to access the conveying lanes of the transfer conveyor 103 for picking up or dropping off packages. Those skilled in the art will further recognize that no stopping, or lifting is required by the AMR for either task. The transfer conveyor 103 and alignment fingers 117a, 117b, 117c, 117d, 117e, 117f, 117g, 117h, and 117i) can be level or angled in a cantilevered manner in a range from 0 to 10 degrees of downward slope. The system 101 can be operated as a flat conveyor or on an incline. This allows a low-profile AMR 113 to use the system 100 in both drop-off and pick-up scenarios. If customer space allows, the AMR 113 can move and/or travel through the fingers (117a, 117b, 117c, 117d, 117e, 117f, 117g, 117h, and 117i), passing underneath conveyor 101 and allowing access to the conveying lanes from either side. Otherwise, an AMR 113 can enter and exit from the end point enabling a continuous AMR flow for picking-up and dropping-off of packages.

### New Methods of Use With an AMR for Package Drop-Off and Pick-Up

Using the high-speed continuous AMR Pick-up and Drop-off System as described herein, new methods and processes of package transport using an AMR are possible. More specifically, the AMR package Drop-off Operation includes a number of novel steps. The AMR drop-off process 200A starts 201 where an AMR approaches 203 the transfer conveyor where it configures itself into a pre-unload position 205. A control signal then automatically activates the conveying system 207. The AMR then matches the speed of the finger conveyors 209 and travels through the finger lanes 211. The finger conveyor lifts 213 the package off the top of the AMR, and onto the finger conveyors. The AMR continues moving 215 under the conveyor to a stop position and waits for the package to exit the finger lanes. In other embodiments, the AMR can stop itself at the finger conveyor and reverse out in an opposite direction and then continue with its route. This is a continuous process where a second AMR can then approach the transfer conveyor 217.

Similarly, the AMR Pick-up Operation also includes a number of novel steps. The process 200B starts 251 where the AMR approaches the transfer conveyor to a “hold” position 253. A package ready sensor signals the AMR to travel through the finger conveyors to a designated stop position under the conveyor 255. The transfer conveyor then measures the package length 257 using an array of photo-eyes or sensors at the end of a predetermined zone. Once a package length is determined, this measurement is used to initiate all conveyors when the AMR leaves the transfer conveyor 261. Thereafter, the roller conveyor and transfer conveyor work to coordinate to a center point by placing a package onto the top of the AMR 265.

Thus, embodiments of the present invention are directed to a high-speed autonomous mobile robot (AMR) pick-up and drop-off conveyor system that includes a straight or herringbone centering roller conveyor. A transfer conveyor (also called a “finger conveyor”) is connected to the roller conveyor at one end. The roller conveyor and transfer conveyor are powered using at least one motorized drive roller (MDR) to achieve a low conveyor profile. The transfer conveyor can be cantilevered at a 0 to 10 degree angle, allowing the AMR to drive under the transfer conveyor and enabling a continuous flow of dropping off or picking up packages.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A high-speed autonomous mobile robot (AMR) pick-up and drop-off conveyor system comprising:
a roller conveyor;
a transfer conveyor connected to the roller conveyor at one end; and
wherein the roller conveyor and transfer conveyor are powered using at least one motorized drive roller (MDR) to achieve a low conveyor profile in relation to the floor and further where the transfer conveyor is cantilevered allowing an AMR to drive under the transfer conveyor.

2. A high-speed AMR conveyor system, as in claim 1, where the transfer conveyor uses a plurality of slanted rollers for centering a package on the roller conveyor.

3. A high-speed AMR conveyor system as in claim 2, where the plurality of slanted rollers form two rows slanted towards a center.

4. A high-speed AMR conveyor system, as in claim 1, where the roller conveyor is a raised conveyor.

5. A high-speed AMR conveyor system, as in claim 1, wherein the transfer conveyor includes a plurality of alignment fingers extending outwardly from the transfer conveyor for aligning an AMR approaching the transfer conveyor.

6. A high-speed AMR conveyor system, as in claim 1, wherein the transfer conveyor forms a plurality of lanes for transferring a package to the AMR.

7. A high-speed autonomous mobile robot (AMR) pick-up and drop-off conveyor system comprising:
a roller conveyor;
a transfer conveyor connected to the roller conveyor at one end and having a plurality of alignment fingers extending outwardly from the transfer conveyor for aligning an AMR approaching the transfer conveyor; and
wherein the roller conveyor and transfer conveyor are powered using at least one motorized drive roller (MDR) to achieve a low conveyor profile in relation to the floor and further where the transfer conveyor is cantilevered allowing an AMR to drive under the transfer conveyor.

8. A high-speed AMR conveyor system, as in claim 7, where the transfer conveyor uses a plurality of slanted rollers for centering a package on the roller conveyor.

9. A high-speed AMR conveyor system as in claim 8, where the plurality of slanted rollers that form two rows slanted towards a center.

10. A high-speed AMR conveyor system, as in claim 7, where the roller conveyor is a raised conveyor.

11. A high-speed AMR conveyor system, as in claim 7, wherein the transfer conveyor forms a plurality of lanes for transferring a package to the AMR.

12. A high-speed autonomous mobile robot (AMR) pick-up and drop-off conveyor system comprising:
a roller conveyor;
a transfer conveyor connected to the roller conveyor at one end where the transfer conveyor is cantilevered allowing an AMR to drive under the transfer conveyor; and
wherein the roller conveyor and transfer conveyor are powered using at least one motorized drive roller (MDR) to achieve a low conveyor profile in relation to the floor and further where the transfer conveyor is configured to form a plurality of lanes for transferring a package to the AMR.

13. A high-speed AMR conveyor system, as in claim 12, where the transfer conveyor uses a plurality of slanted rollers for centering a package on the roller conveyor.

14. A high-speed AMR conveyor system as in claim 13, where the plurality of slanted rollers form two rows slanted towards a center.

15. A high-speed AMR conveyor system, as in claim 12, where the roller conveyor is a raised conveyor.

16. A high-speed AMR conveyor system, as in claim 12, wherein the transfer conveyor includes a plurality of alignment fingers extending outwardly from the transfer conveyor for aligning an AMR approaching the transfer conveyor.
